(19) United States
(12) Patent Application Publication
(10) Pub. No.: US 2018/0186472 A1
(43) Pub. Date: Jul. 5, 2018

(54) METHOD AND APPARATUS FOR AN UNMANNED AERIAL VEHICLE WITH A 360-DEGREE CAMERA SYSTEM

(71) Applicant: Airmada Technology Inc., Fremont, CA (US)

(72) Inventors: Zhimin Wan, Milpitas, CA (US); Ben Freudberg, San Jose, CA (US); Neal Jing, Fremont, CA (US); Peicong Liu, San Lorenzo, CA (US); Kevin Kelin Wan, Champaign, IL (US); Minh Dang, Morgan Hill, CA (US); Long Cheng, Fremont, CA (US)

(73) Assignee: Airmada Technology Inc.

(21) Appl. No.: 15/857,429

(22) Filed: Dec. 28, 2017

Related U.S. Application Data
(60) Provisional application No. 62/440,816, filed on Dec. 30, 2016.

(51) Int. Cl. B64D 47/08; B64C 39/02; B64C 25/52; B64C 25/10; H04N 5/232; H04N 7/18

(52) U.S. Cl. CPC B64D 47/08; B64C 39/024; B64C 25/52; B64C 25/10; H04N 13/0239; H04N 5/23238; B64C 2025/325; B64C 2201/024; B64C 2201/042; B64C 2201/108; B64C 2201/127; B64C 2201/165; H04N 7/181

(57) ABSTRACT

Described herein is an unmanned aerial vehicle (“UAV”) apparatus comprising a 360-degree camera system mounted onboard a UAV platform. The camera system comprises a pair of cameras with a pair of wide-angle lenses that have a collective angle of view equal to or greater than 360 degrees, and as such, the lenses can capture images of the entire 360-degree spherical space surrounding the apparatus, except for an exclusive region defined by an overlap radius. The overlap radius is calculated using the equation R=H/[tan(α−180 degrees)+tan(β−180 degrees)], wherein α and β are the respective angles of view of the lenses, and H is the vertical distance between the lenses. The UAV platform comprises a body with a symmetric appearance and a retractable landing gear that can retract within the body during flight and extend out at landing.

### CROSS-REFERENCE TO RELATED APPLICATIONS

This application claims priority under relevant sections of 35 U.S.C. § 119 to U.S. Provisional Application No. 62/440,816, filed on Dec. 30, 2016, which is hereby incorporated by reference in its entirety.

### FIELD OF THE INVENTION

The present invention generally relates to unmanned aerial vehicle (“UAV”) technologies, and more particularly, is directed to configuring a UAV device for photography or video recording with a minimal number of camera lenses.

### BACKGROUND

360-degree cameras have been developed and applied in event recording in recent years. This technology allows a full view of the environment around the camera, so that any part of the environment can be zoomed in at real time or at a later time using software to reveal the details. However, such a 360-degree camera usually comprises more than two cameras and lenses, making the image stitching process complicated and the hardware expensive. For example, FIGS. 1a-c show some preexisting robot, drone and UAV devices that use multiple lenses to capture images in the 360-degree space surrounding the device. Besides the hardware cost, having multiple cameras and lenses also increase the total weight of the hardware, which, in the case of flying devices such as a drone or UAV, would hamper the flight performance or operating duration of these devices. Therefore, it is necessary to reduce the number of lenses used to cover the 360-degree space, and simplify the image stitching process. In addition, as shown in FIG. 1c, many existing UAV devices are installed with landing gears and cameras separate from the body, which makes the devices look cumbersome and unappealing. Therefore, a further need exists for an integrated design to incorporate the 360-degree camera into the UAV body so as to give the device a harmonious appearance for purposes of commercialization.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

The present invention is directed to an unmanned aerial vehicle (UAV) apparatus comprising a 360-degree camera system mounted onboard a UAV platform. The UAV platform comprises a UAV body, the UAV body comprising a top member and a bottom member, wherein both the top and bottom members are dome-shaped and symmetrically positioned to each other to form a housing that has an interior space; and a 360-degree camera system fixed to the UAV platform and positioned in the interior space of the housing, the 360-degree camera system comprising a first camera coupled to a first lens with a first angle of view, and a second camera coupled to a second lens with a second angle of view, wherein the first and second angles of view have a collective angle of view equal to or greater than 360 degrees, the first and second lenses are extendable from a top opening of the top member and a bottom opening of the bottom member, respectively, and the first and second lenses, while extended out from the respective top and bottom openings, have horizontal positions near a central vertical axis of a plane formed by four corners of the UAV body and vertical positions relative to each other separated by a vertical distance H.

Another embodiment is directed to a method for configuring an apparatus as stated above.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1a-c are preexisting robot, drone and UAV devices fitted with multiple cameras and lenses;

FIGS. 2a-b provide side views of two exemplary UAV devices according to embodiments of the invention;

FIG. 3 is a perspective view of an exemplary UAV device according to embodiments of the invention;

FIGS. 4a-b illustrate exemplary configurations of a retractable landing gear in the UAV of FIGS. 2a-b or FIG. 3 according to embodiments of the invention; and

FIG. 5 is a top view of an exemplary body design of the UAV of FIGS. 2a-b or FIG. 3 according to embodiments of the invention.

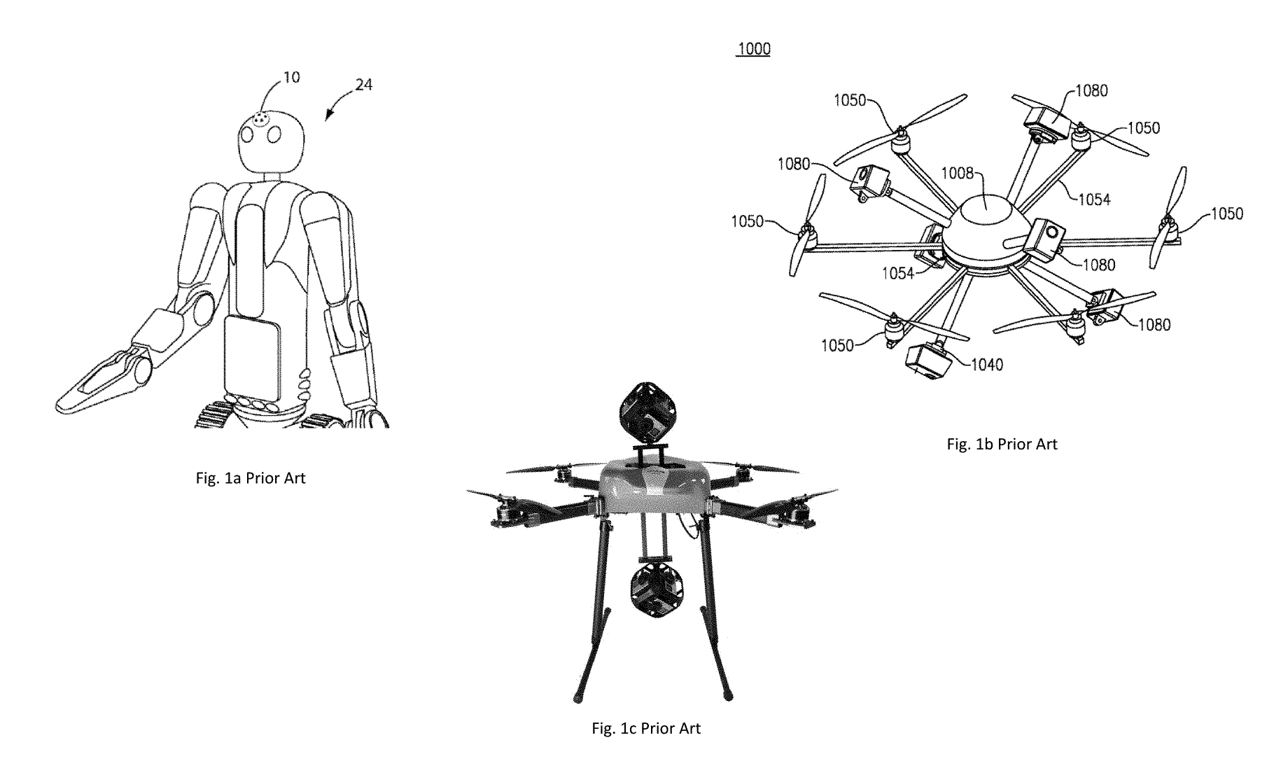

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, embodiments of the present invention are not intended to be limited to the examples described herein and shown, but is to be accorded the scope consistent with the claims.

The term “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Embodiments disclosed herein are directed to an unmanned aerial vehicle (“UAV”) apparatus comprising a 360-degree camera system mounted onboard a UAV platform. In one embodiment, the camera system comprises a pair of cameras with a pair of wide-angle lenses that have a collective angle of view equal to or greater than 360 degrees, and as such, the lenses can capture images of the entire 360-degree spherical space surrounding the apparatus, except for an exclusive region defined by an overlap radius. The overlap radius is calculated using the equation R=H/[tan(α−180 degrees)+tan((3-180 degrees)], wherein α and 0 are the respective angles of view of the lenses, and H is the vertical distance between the lenses. The UAV platform comprises, among other things, a body with a symmetric appearance and a retractable landing gear that can retract within the body during flight and extend out at landing.

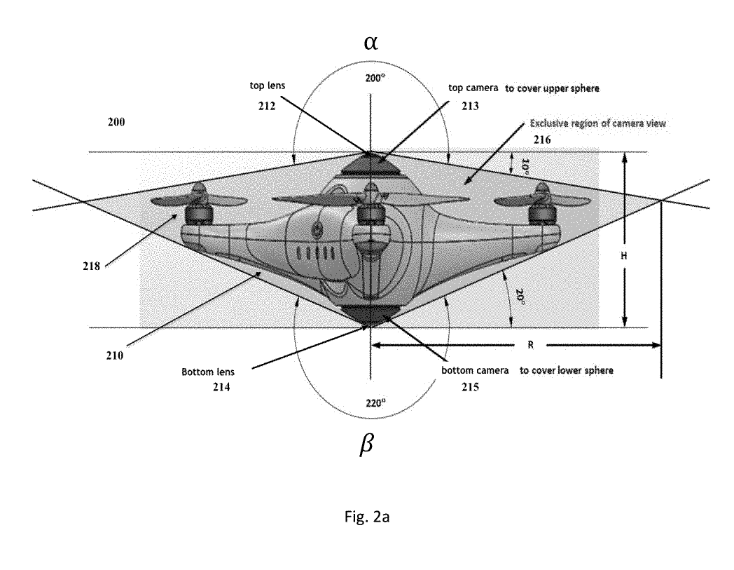

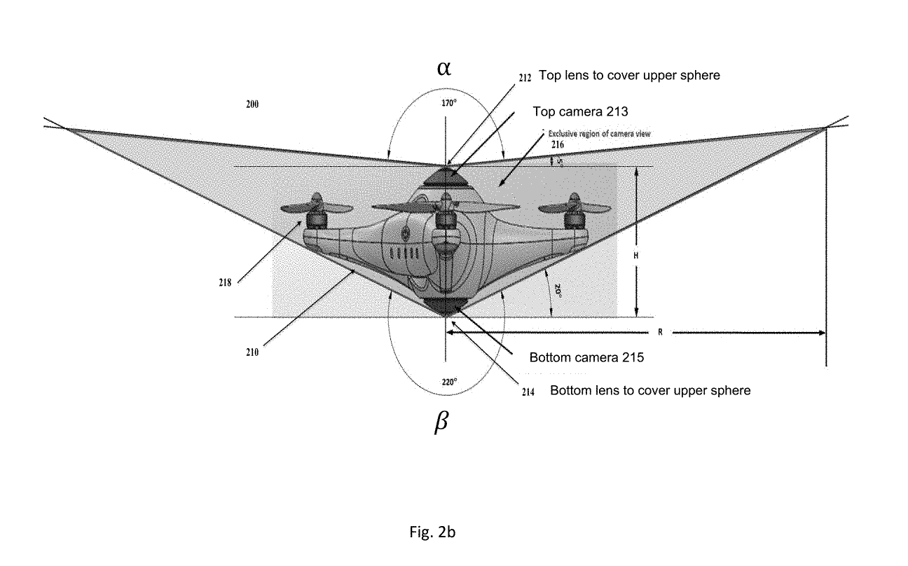

Referring now to FIGS. 2a-b, two exemplary UAVs with a 360-degree camera system according to embodiments of the invention will be described herein below. As shown in FIGS. 2a-b, each exemplary UAV 200 comprises a 360-degree camera system mounted onboard a UAV platform, which, among other things, comprises at least a UAV body 210 and a motor and propeller system 210 having three or more motors and propellers.

In one embodiment, the motors and propellers 218 are symmetrically positioned in the UAV body 210 so that they extend radially from a central vertical axis of a plane formed by four corners of the UAV body.

In both exemplary UAVs, the 360-degree camera system comprises a top lens 212 coupled to a top camera 213 and mounted to a top portion of the UAV body 210 and a bottom lens 214 coupled to a bottom camera 215 and mounted to a bottom portion of the UAV body 210. In one embodiment, the top lens 212 and bottom lens 214 have angles of view α and β, respectively, and the collective angle of view for these lenses is equal to or greater than 360 degrees. In one configuration, the top and bottom lenses can be wide-angle lenses that have an angle of view exceeding 220 degrees, such as “fisheye” lenses. For instance, as seen in FIG. 2a, the top lens 212 has an angle of view α of 200 degrees, and the bottom lens 214 has an angle of view β of 220 degrees. As such, the collective angel of view of these lenses is greater than 360 degrees. In the other example as shown in FIG. 2b, the angles of view α and β are 170 degrees and 220 degrees, respectively, and thus, the collective angel of view is, again, greater than 360 degrees. As compared to existing UAV devices, such a configuration according to embodiments of the invention can effectively reduce the number of lenses to cover the entire 360-degree spherical space around the UAV body, thereby reducing the weight of the UAV device. In addition, unlike existing UAV devices, no more than two lenses are needed in the present invention, and as such, only two captured images need to be stitched together, which greatly simplifies the image stitching process.

Once images are captured with the top lens 112 and the bottom lens 114, they are then stitched together to form a composite image showing the entire 360-degree spherical space surrounding the UAV 200, with the exception of an exclusive region 216 near the UAV body 210 and the motor and propeller system 218. The radius of the exclusive region 216, namely, the overlap radius R, can be calculated by the following equation: R=H/[tan(α−180)+tan(β−180 degree)], wherein α is the top angle of view, β is the bottom angle of view, and H is the vertical distance between the top lens 212 and the bottom lens 214. In this case, for any given distance H, the greater the angles of view of the lenses, the smaller the overlap radius R, which gives the maximum viewing space around the UAV 200.

Using the exemplary UAV in FIG. 2a for illustration, the top lens 212 has an angle of view α of 200 degrees, and the bottom lens 214 has an angle of view β of 220 degrees. Assuming the distance H between the top lens 212 and bottom lens 214 is 120 mm, the overlap radius R=120 mm/(tan 10 deg+tan 20 deg)=222 mm. On the other hand, in the exemplary UAV device shown in FIG. 2b, the angles of view α and β are 170 degrees and 220 degrees, respectively. Again, for the same distance, H=120 mm, using the above equation, the overlap radius R=120 mm/[tan(−5 deg)+tan(20 deg)]=434 mm. Because the lenses in FIG. 2a have a greater collective angel of view, the overlap radius R is smaller than that of the exemplary UAV device in FIG. 2b. In both cases, the exclusive region 216 is sufficiently small to allow the 360-degree camera system to capture images of most of the surroundings around the UAV 200, regardless whether it is outdoors or in the confined spaces of a small room.

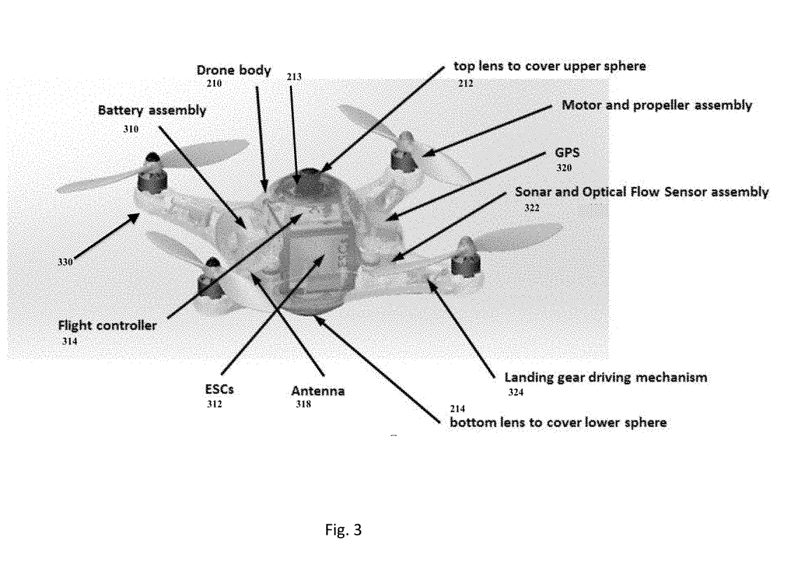

FIG. 3 provides a perspective view of an exemplary UAV device, which shows various components for the UAV platform and their relative positions inside the UAV body 210. For example, these components may include a battery assembly 310, one or more electronic speed controls (“ESCs”) 312, a flight controller 314, antennas 318, GPS 320, a sonar and optical flow sensor assembly 322, which may include a combination of one or more sonar sensors and optical flow sensors, as well as a landing gear driving mechanism 324. Other components (not shown), such as a video card installed in the 360-degree camera system, may be included as well according to various embodiments of the invention.

In one embodiment, the antennas 318 comprise two Wi-Fi antennas located on two of the UAV arms 330 for receiving control signals and sending data to the UAV device. It would be apparent to a person having ordinary skill in the art that the antennas 318 may also include antennas configured to receive and send data via other ways of communication, such as radio frequency, blue-tooth and infrared. The control signal received by one of the antennas is then communicated to the flight controller 314. Typically, the flight controller 314 comprises a microprocessor and is connected to various sensors, such as accelerometer, gyroscope, GPS 320, the sonar and optical flow sensors 322, and so forth. The flight controller 314 is programmed to receive sensor data, calculate and control movement of the UAV 200 by making adjustments to the motor and propeller system 218. The GPS 320 calculates the location of the UAV 200 and communicates the location of the UAV device to the flight controller 314 and/or the operator of the UAV device.

The sonar sensor of the sensor assembly 322 detects the altitude of the UAV 200 and sends the data to the flight controller 314, which is configured to allow the UAV 200 to hover at a designated altitude to improve vertical stabilization of the UAV 200 as well as the quality of the images taken by the cameras. In addition, the UAV 200 may use an optical flow sensor of the sensor assembly 322 to further improve horizontal stabilization of the UAV 200 and quality of the images taken by the cameras.

The battery assembly 310 generally provides the power for the UAV platform, and can also be configured to power the camera system. Since battery cells are heavy and usually account for around 30% of the total UAV weight, they are positioned near the center of the UAV 200 in order to keep the center of gravity near the geometric center, which then allows the load on each motor 218 to be substantially balanced, thereby optimizing the power efficiency.

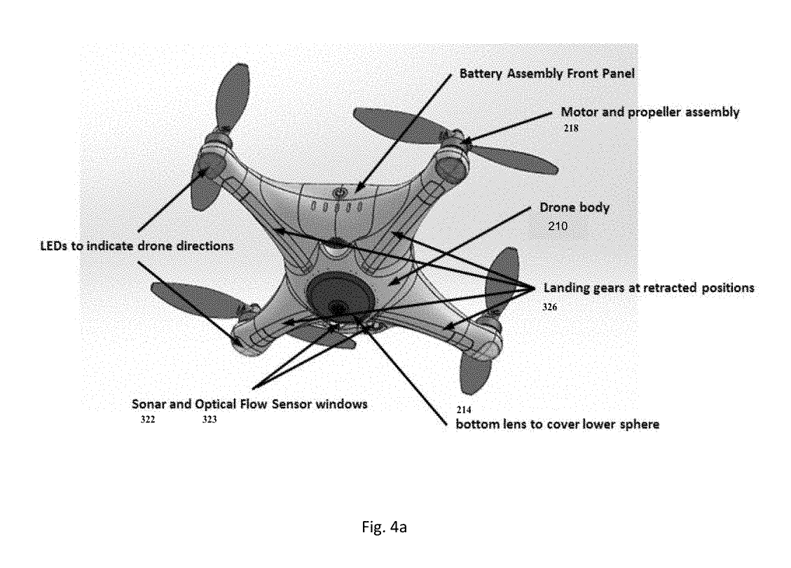

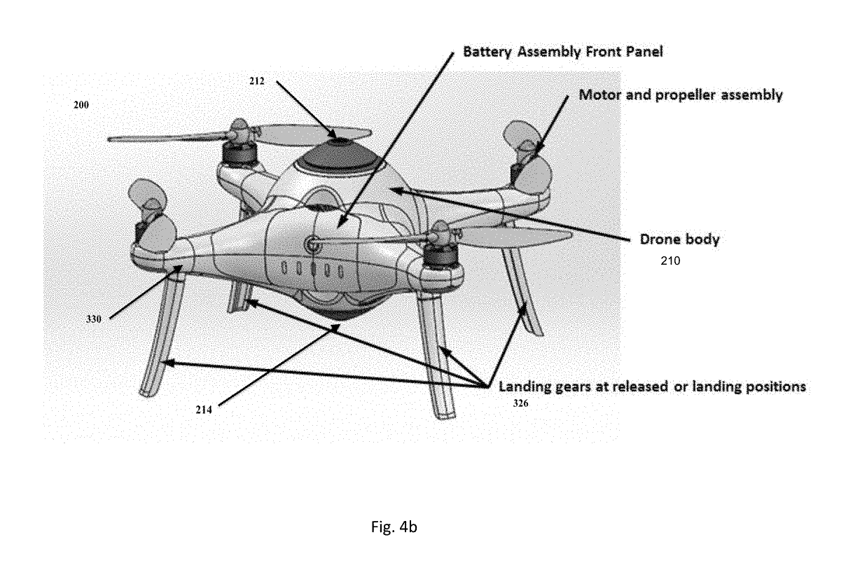

According to one embodiment, the UAV 200 further comprises a landing gear driving mechanism 324 to allow the landing gear 326 (as shown in FIGS. 4a-b) to release and retract. In one embodiment, such landing gear 326 and landing gear driving mechanism 324 are positioned under the motor and propeller system 218, and housed within the hollow UAV arms 330.

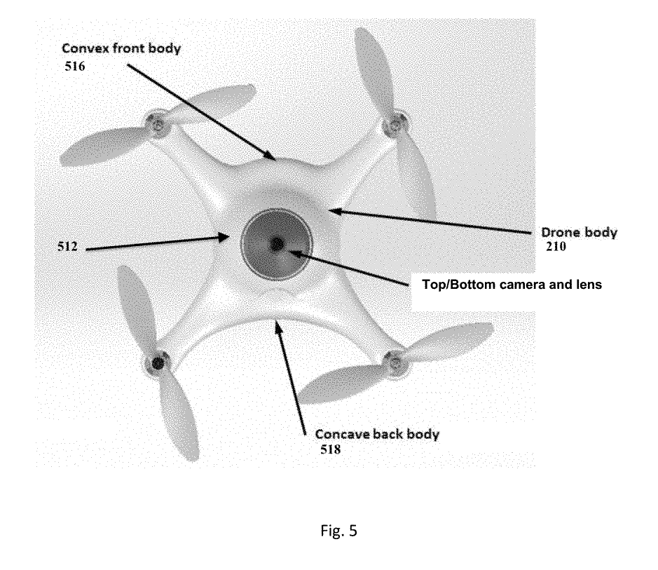

As shown in FIGS. 4a-b, one embodiment of the UAV 200 comprises a retractable landing gear 326 designed to support the UAV 200 and the equipment onboard. As shown in FIG. 4a, the landing gear 326 comprises a set of retractable legs, with each leg attached to the bottom of an UAV arm 330. Upon landing, the landing gear 326 extends out from the UAV arms 330 to prop up the UAV 200 so that the bottom lens 214 does not come in contact with the ground. Furthermore, the landing gear 326 should be such positioned that it does not block the view of the top lens at landing. While the UAV device is in the flight mode, as illustrated in FIG. 4a, the landing gear 326 retracts into the UAV arms 330 to give the top lens 212 and the bottom lens 214 an unobstructed or substantially unobstructed view of the entire spherical space around the UAV 200, with exception of the exclusive region 216. In practice, the retractable landing gear 326 does not need to be completely retracted into the UAV arms 330, although a complete retraction would give the UAV 200 a harmonious appearance. Furthermore, the landing gear 326 may be configured to extend and retract automatically based on the altitude of the UAV 200 as detected either by the sonar sensor of the sensor assembly 322 or by the operator manually controlling the UAV device. FIG. 5 shows an exemplary design of the UAV body 210 according to one embodiment of the invention. The UAV body 210 designed with a proper shape can maximize the image coverage of the surrounding environment and give the UAV 200 sufficient strength and internal space to accommodate the camera system and other components. As shown in FIG. 5, the UAV body 210 comprises a housing within which the cameras and other UAV components are located. In one embodiment, the housing comprises a dome-shaped top portion 512, a domed-shaped bottom portion (not shown) that is almost identical to the top 512, a convex front portion 516, and a concave back portion 518. In one embodiment, there are respective openings in the top and the bottom of the housing that allow the top lens 212 and the bottom lens 214 to extend out from the UAV body 210. The dome-shaped top and bottom portions are symmetric to each other, which allows the top lens 212 and the bottom lens 214 to have a symmetric and unobstructed view of the entire spherical space surrounding the UAV 200. On the other hand, the asymmetric front 516 and back 518 allow the operator of the UAV device to visually identify a nominal “forward” direction under a predefined coordinate system for guiding the UAV 200.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

What is claimed is:

1. An unmanned aircraft vehicle (“UAV”) apparatus comprising:
a UAV platform comprising a UAV body, the UAV body comprising a top member and a bottom member, wherein both the top and bottom members are dome-shaped and symmetrically positioned to each other to form a housing that has an interior space; and
a 360-degree camera system fixed to the UAV platform and positioned in the interior space of the housing, the 360-degree camera system comprising a first camera coupled to a first lens with a first angle of view, and a second camera coupled to a second lens with a second angle of view,
wherein the first and second angles of view have a collective angle of view equal to or greater than 360 degrees,
the first and second lenses are extendable from a top opening of the top member and a bottom opening of the bottom member, respectively, and
the first and second lenses, while extended out from the respective top and bottom openings, have horizontal positions near a central vertical axis of a plane formed by four corners of the UAV body and vertical positions relative to each other separated by a vertical distance H.

2. The apparatus of claim 1, wherein the UAV platform further comprises:
a motor and propeller system having three or more motor and propellers;
a battery assembly;
one or more electronic speed controls (ESCs);
a flight controller;
a GPS;
a sonar and optical flow sensor comprising one or more sonar sensors and optical flow sensors; and
a landing gear positioned under the motor and propeller system, the landing gear comprising a set of retractable legs.

3. The apparatus of claim 2, wherein the first lens is positioned above the motor and propeller system, and the second lens is positioned below the motor and propeller system.

4. The apparatus of claim 2, wherein the UAV body further comprises three or more arm members, and each arm member is attached to one of the retractable legs of the landing gear so that during flight, the retractable legs are retracted within the arm members, and at landing, the retractable legs extend out from the arm members to support the UAV platform.

5. The apparatus of claim 1, wherein the UAV body further comprises a convex front member and a concave back member, the front and back members having an asymmetric appearance to allow for an identification of a nominal front or forward flight direction.

6. The apparatus of claim 1, the first lens is configured to capture images of a top hemispherical space surrounding the UAV body, the second lens is configured to capture images of a bottom hemispherical space surrounding the UAV body.

7. The apparatus of claim 1, wherein the first and second lenses have a symmetric and unobstructed view of an entire space surrounding the UAV body, the first angle of view is greater than or equal to 180 degrees, and the second angle of view is greater than or equal to 180 degrees.

8. The apparatus of claim 1, wherein the first and second lenses have a symmetric and unobstructed view of an entire spherical space surrounding the UAV body, the first angle of view is less than or equal to 180 degrees, and the second angle of view is greater than or equal to 180 degrees.

9. The apparatus of claim 1, wherein the collective angle of view of the first and second lenses covers an entire 360-degree spherical space surrounding the UAV body, except an exclusive region defined by an overlap radius R.

10. The apparatus of claim 9, wherein the overlap radius R is calculated by the following equation: R=H/[tan(α−180 degrees)+tan(β−180 degrees)], wherein H is the vertical distance between the first lens and the second lens, α is the first angle of view in degrees, and β is the second angle of view in degrees.

11. A method for configuring an unmanned aircraft vehicle (“UAV”) apparatus with a 360-degree camera system, comprising:
configuring a UAV platform with a UAV body, the UAV body comprising a top member and a bottom member, wherein both the top and bottom members are dome-shaped and symmetrically positioned to each other to form a housing that has an interior space; and
configuring a 360-degree camera system with a first camera coupled to a first lens with a first angle of view, and a second camera coupled to a second lens with a second angle of view, wherein the 360-degree camera system is fixed to the UAV platform and positioned in the interior space of the housing,
wherein the first and second angles of view have a collective angle of view equal to or greater than 360 degrees,
the first and second lenses are extendable from a top opening of the top member and a bottom opening of the bottom member, respectively, and
the first and second lenses, while extended out from the respective top and bottom openings, have horizontal positions near a central vertical axis of a plane formed by four corners of the UAV body and vertical positions relative to each other separated by a vertical distance H.

12. The method of claim 11, further comprising configuring the UAV platform with components comprising:
a motor and propeller system having three or more motor and propellers;
a battery assembly;
one or more electronic speed controls (ESCs);
a flight controller;
a GPS;
a sonar and optical flow sensor comprising one or more sonar sensors and optical flow sensors; and
a landing gear positioned under the motor and propeller system, the landing gear comprising a set of retractable legs.

13. The method of claim 12, wherein the first lens is positioned above the motor and propeller system, and the second lens is positioned below the motor and propeller system.

14. The method of claim 12, wherein the UAV body further comprises three or more arm members, and each arm member is attached to one of the retractable legs of the landing gear so that during flight, the retractable legs are retracted within the arm members, and at landing, the retractable legs extend out from the arm members to support the UAV platform.

15. The method of claim 11, wherein the UAV body further comprises a convex front member and a concave back member, the front and back members having an asymmetric appearance to allow for an identification of a nominal front or forward flight direction.

16. The method of claim 11, the first lens is configured to capture images of a top hemispherical space surrounding the UAV body, the second lens is configured to capture images of a bottom hemispherical space surrounding the UAV body.

17. The method of claim 1, wherein the first and second lenses have a symmetric and unobstructed view of an entire space surrounding the UAV body, the first angle of view is greater than or equal to 180 degrees, and the second angle of view is greater than or equal to 180 degrees.

18. The method of claim 11, wherein the first and second lenses have a symmetric and unobstructed view of an entire spherical space surrounding the UAV body, the first angle of view is less than or equal to 180 degrees, and the second angle of view is greater than or equal to 180 degrees.

19. The method of claim 11, wherein the collective angle of view of the first and second lenses covers an entire 360-degree spherical space surrounding the UAV body, except for an exclusive region defined by an overlap radius R.

20. The method of claim 19, wherein the overlap radius R is calculated by the following equation: R=H/[tan(α−180 degrees)+tan(β−180 degrees)], wherein H is the vertical distance between the first lens and the second lens, α is the first angle of view in degrees, and β is the second angle of view in degrees.
